(19) United States
(12) Patent Application Publication
(10) Pub. No.: US 2018/0063670 A1
(43) Pub. Date: Mar. 1, 2018

(54) BACKGROUND MANAGEMENT OF MOBILE APPLICATIONS

(71) Applicant: Microsoft Technology Licensing, LLC, Redmond, WA (US)

(72) Inventors: Neeraj Garg, Hyderabad (IN); Ashish Saxena, Hyderabad (IN); Amrut Kale, Hyderabad (IN); Abhineet Bansal, Hyderabad (IN)

(21) Appl. No.: 15/249,303

(22) Filed: Aug. 26, 2016

(51) Int. Cl. H04W 4/00; H04L 29/06; H04L 29/08

(52) U.S. Cl. CPC H04W 4/003; H04L 67/42; H04L 67/16; H04L 65/1063; H04L 67/06; H04L 67/2842

(57) ABSTRACT

Background threads are used to execute various background tasks for mobile applications that are inactive on mobile client devices. A background service monitors telemetry data of the mobile client device and interacts with an application service that provides various services for triggering and responding to the background tasks of the mobile applications. The background tasks are scheduled for execution during timeframes that have historically shown to be times that the mobile application is not actively engaged by a user. The telemetry data collected by the mobile client device may be transmitted and used by the application server to identify the presence of mobile applications on mobile computing devices, locate bugs in the mobile applications, modify shared files, move files of lesser-used mobile applications in and out of cache memory, package application download packages specific to the users of the mobile client devices, and provide application upgrades.

### BACKGROUND

The ubiquity of today's mobile computing devices has created a new computing environment whereby users can easily download task-specific software applications through online application stores and run the applications on demand. Millions of applications are at the user's fingertips, providing services for everything from video editing to online banking. As modern computing transitions toward mobile smartphones, tablets, and wearables, the popularity of mobile applications will only increase.

Conventional mobile operating systems (OSes) only allow mobile applications to use the processing resources of a mobile device when the application is actively running. For instance, an application may be guaranteed processing cycles only when the application has been launched, but once the application is closed, the cycles are no longer accessible to the application. This requires today's mobile applications to perform as many tasks as possible while launched, but many tasks have nothing to do with and are not perceptible to a user, such as upgrades, patches, communication of sensor or user profile data, etc.

Users open applications for access to the services they provide and largely do not care about application maintenance or data collection. For the most part, users only care about how well a mobile application performed its intended service. Using allocated processing and storage resources of the mobile device to handle these non-user oriented tasks while an application is running, or active, comes at a resource cost that slows down user-oriented tasks the application performs. For example, a mobile banking application using its allocated processing cycles on downloading and installing an upgrade leaves fewer processing cycles for retrieving account balances being requested by the user, and the less the user friendly the application becomes, the less likely users will continue using it. Degradation of the user experience at the expense at having to perform non-user experience tasks while the application is active may come at a heavy cost to the widespread acceptance of the application.

### SUMMARY

The disclosed examples are described in detail below with reference to the accompanying drawing figures listed below. The following summary is provided to illustrate some examples disclosed herein, and is not meant to necessarily limit all examples to any particular configuration or sequence of operations.

Some of the disclosed examples are directed to controlling performing background tasks for mobile applications on a mobile device while the mobile applications are inactive. Put another way, tasks for the mobile applications are performed on background threads to ensure that, when the mobile applications are run by users, processing and storage resources are not wasted on updating the mobile applications themselves. To this end, background tasks for the mobile applications are scheduled to be processed according to task alarms and task conditions to trigger when the users of the mobile client devices are not actively engaging the mobile applications. For example, task alarms may be set for early morning when a particular user is typically—or at least has historically been—asleep. A background task interface provides the ability to execute the background tasks while a mobile application in inactive when the task alarms are triggered. In some examples, task conditions include temporal task alarms.

Some of the disclosed examples are directed to an application server that receives various telemetry data for mobile client devices and, in response to some of the telemetry data, schedules various background tasks to be executed. Additionally or alternatively, the application server may provide various services in response to the background tasks being executed by the mobile client devices. The application server may signal that application files are to be moved into or out of cache on the mobile client devices, track the length of time mobile applications are stored and used or not used, send modifications of shared files, provide bug patches, transmit application upgrades, store and analyze device telemetry data, or selectively package application download files specific to users or the mobile client devices.

### BRIEF DESCRIPTION OF THE DRAWINGS

The disclosed examples are described in detail below with reference to the accompanying drawing figures listed below:

FIG. 1 is a block diagram of an example mobile computing device configured to manage mobile applications using background tasks.

FIG. 2 is a block diagram illustrating an example networking environment for managing mobile applications using background tasks.

FIG. 3 is a multi-axis timeline diagram illustrating various background tasks operating at different times.

FIG. 4 is a single-axis timeline diagram illustrating files being moved into and out of cache memory.

FIG. 5 is a block diagram of a framework for implementing application tasks in background threads of a client device.

FIGS. 6-7 are flowchart diagrams showing executable work flows for processing tasks of mobile applications while the mobile applications are inactive.

Corresponding reference characters indicate corresponding parts throughout the drawings.

### DETAILED DESCRIPTION

As mentioned above, conventional mobile operating systems only allow resident mobile applications to run when they are active, thereby forcing the mobile applications to execute all maintenance, updating, and processing tasks when users are actively using the applications. The examples disclosed herein generally relate to performing mobile application tasks in the background of a mobile device when the applications are not actively running. Along these lines, some examples provide a background service on the mobile device referred to herein as the “Background Task Interface,” which allows the mobile device's applications to execute tasks even when the mobile applications are not active.

To clarify the disclosed examples, reference is made herein to applications being in an “active” state or an “inactive” state. An active state refers to a mobile application that has been launched and is currently open or being executed by a mobile device. An inactive state refers to an application that has been closed and not be executed by a mobile device. Inactive applications are stored on the mobile device, available to be run upon instruction of the user, but that are not currently being run. Applications that are inactive may use the Background Task Interface to schedule and perform tasks that would conventionally need to be performed during the active state.

In some example, the Background Task Interface service may run out-of-process, meaning in a different process than the actual application itself. In some examples, the Background Task Interface may be configured to never run in conjunction when the application is in an active state. If the application is running when the Background Task Interface is triggered, the Background Task Interface may be configured to kill itself. Also, if the application is invoked while the Background Task Interface is running, the Background Task Interface may be killed.

Some examples in particular include instructions that direct mobile applications to wait for periods of user or network inactivity (e.g., late at night when users are likely asleep or networks are experiencing lower volumes of traffic) and then perform various maintenance, updating, or other processing tasks on background threads of the mobile device.

Additionally or alternatively, application tasks may be performed in the background based on a multitude of other triggers, such as, for example but without limitation, when the mobile device boots up, when an application is upgraded, when an application is added or removed, during predefined times of a day/week/month, or the like. Additional conditions for executing background processing are explained in more detail below.

A “task,” as discussed herein, refers to the various processing jobs of a mobile application. These may include application-function instructions of an application (e.g., retrieve weather, present the application's user interface, or the like); maintenance and upgrading instructions of an application (e.g., bug patches, new version downloads, or the like); modifications of related documents or files associated with an application (e.g., modifying a word processing document according to the latest version being stored in cloud, removing a video rented for a particular amount of time, or the like); modifications of support files for an application (e.g., native libraries, shared object files, or the like); or any other processing tasks that is directed to be performed by the application. Collectively, these actions, or jobs, will simply be referenced herein as “tasks,” unless otherwise specified.

Moreover, reference is made herein to the collection and transmission of “telemetry data.” Telemetry data refers to data captured on a mobile device, e.g., information from device sensors (e.g., accelerometer, global positioning system, thermometer, microphone, or the like), information regarding network connectivity (e.g., strength or availability), user interaction information (e.g., user touches, text, voice, face, gestures, or the like), Application health (e.g., crash rate, tasks success or failures, file open, file save, file close, or the like), application performance records (e.g., typing speed, scrolling speed, or the like) information from the applications (e.g., browsing history, time stamps of application use, cookies, or the like), performance data (e.g., the application response time in response to some user action, failures in application functionality, failure to open a file, failure to edit a file, user or other information captured by the mobile device.

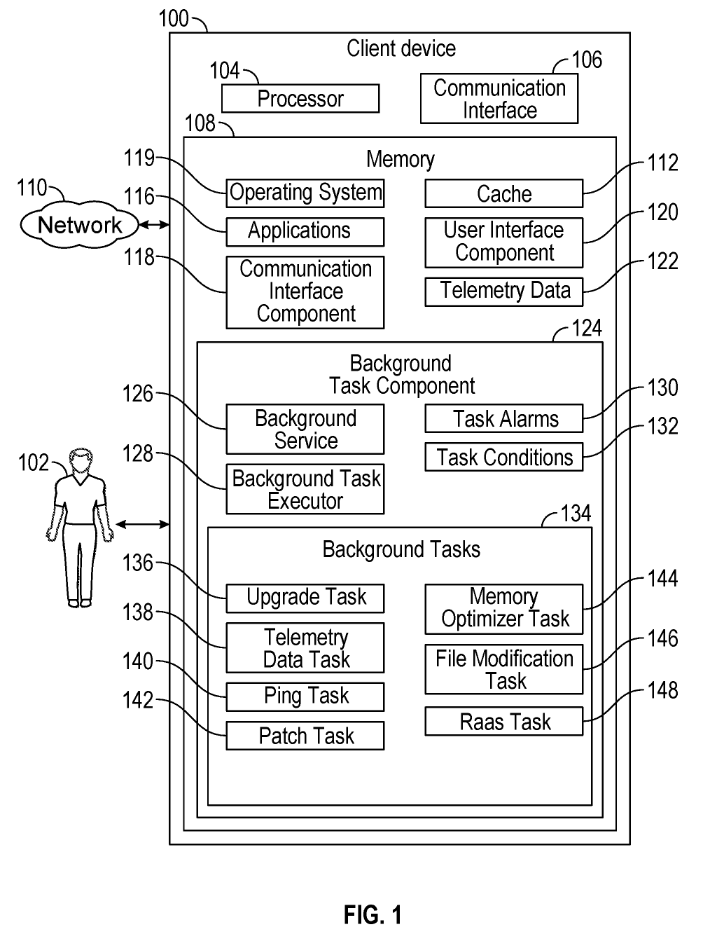

Having generally described at least some of the examples and terms referenced herein, attention is focused on the accompanying drawings for additional details. FIG. 1 is an example block diagram illustrating a mobile client computing device (“client device”) 100 for providing executing tasks of mobile resident applications 116 in background threads while the applications 116 are in an inactive state. The client device 100 represents any mobile computing device executing instructions to implement the operations and functionality described herein associated with the client device 100. The client device 100 may take the form of a mobile computing device or any other portable device, such as, for example but without limitation, a mobile phone (e.g., smart phone), a tablet, a gaming device, a virtual reality (VR) device, a wearable device (e.g., smart glasses, fitness band, electronic watch, etc.), or a portable media player. In other examples, the client device 100 may also include less portable devices such as kiosks, tabletop devices, electric automobile charging stations, electronic component of a vehicle (e.g., a vehicle computer equipped with cameras or other sensors disclosed herein), or the like. Other examples may incorporate the client device 100 as part of a multi-device system in which two separate physical devices share or otherwise provide access to the illustrated components of the client device 100.

Though not shown for the sake of clarity, the client device 100 may include various display components. These display components may include visual, audio, haptic, and other presentation devices for presenting information to a user 102. The display components may include various input/output (“I/O”) devices, I/O ports, and device drivers to display, verbally communicate, or otherwise indicate output to the user 102, including, for example but without limitation, display screens, monitors, touch screens, phone displays, tablet displays, wearable device screens, televisions, speakers, vibrating devices, tactile-morphing screens, headphones and headphone inputs, holographic displays, virtual reality displays, augmented reality displays, or the like. Additional display components readily apparent to one skilled in the art may also be included.

In some examples, the client device 100 has at least one processor 104, a communication interface 106, and computer-storage memory 108. The processor 104 may include any quantity of processing units, and is programmed to execute computer-executable instructions for implementing aspects of the disclosure. The instructions may be performed by the processor, by multiple processors within the client device 100, or by a processor 104 external to the client device 100. In some examples, the processor 104 is programmed to execute instructions such as those illustrated in the flowcharts discussed below and depicted in the accompanying drawings. Moreover, in some examples, the processor 104 represents an implementation of analog techniques to perform the operations described herein. For example, the operations may be performed by an analog client device 100 and/or a digital client device 100.

Memory 108 includes any quantity of memory associated with or accessible by the client device 100. Memory 108 may be internal to the client device 100 (as shown in FIG. 1), external to the client device 100 (not shown), or both (not shown). Examples of memory 108 include, without limitation, random access memory (RAM); cache 112; read only memory (ROM); electronically erasable programmable read only memory (EEPROM); flash memory or other memory technologies; CDROM, digital versatile disks (DVDs) or other optical or holographic media; magnetic cassettes, magnetic tape, magnetic disk storage or other magnetic storage devices; memory wired into an analog computing device; or any other form of device memory.

Memory 108 may also take the form of volatile and/or nonvolatile memory;

may be removable, non-removable, or a combination thereof; and may include various hardware devices (e.g., solid-state memory, hard drives, optical-disc drives, etc.). Additionally or alternatively, memory 108 may be distributed across multiple client devices 100, e.g., in a virtualized environment in which instruction processing is carried out on multiple client devices 100. For the purposes of this disclosure, “computer-storage memory” and “memory” do not include carrier waves or propagating signaling. More specifically, memory 108 is embodied with machine-executable instructions and/or hardware logic that include an operating system 119, applications 116, a communications interface component 118, a user interface component 120, telemetry data 122, and a background task component 124. These illustrated instructions and logic are provided merely as an example of some embodiments referenced herein. Additional or alternative instructions and logic may be included in other examples.

In some examples, the communications interface component 118 includes a network interface card and/or a driver for operating the network interface card. Communication between the client device 100 and other devices may occur using any protocol or mechanism over a wired or wireless connection, or across a network 110. In some examples, the communications interface component 118 is operable with radio frequency (RF) and short-range communication technologies, e.g., near-field communication (NFC) tags, BLUETOOTH® brand tags, or the like. In some examples, the communications interface component 118 communicates with remote content memory of a remote device, such as a server or cloud infrastructure.

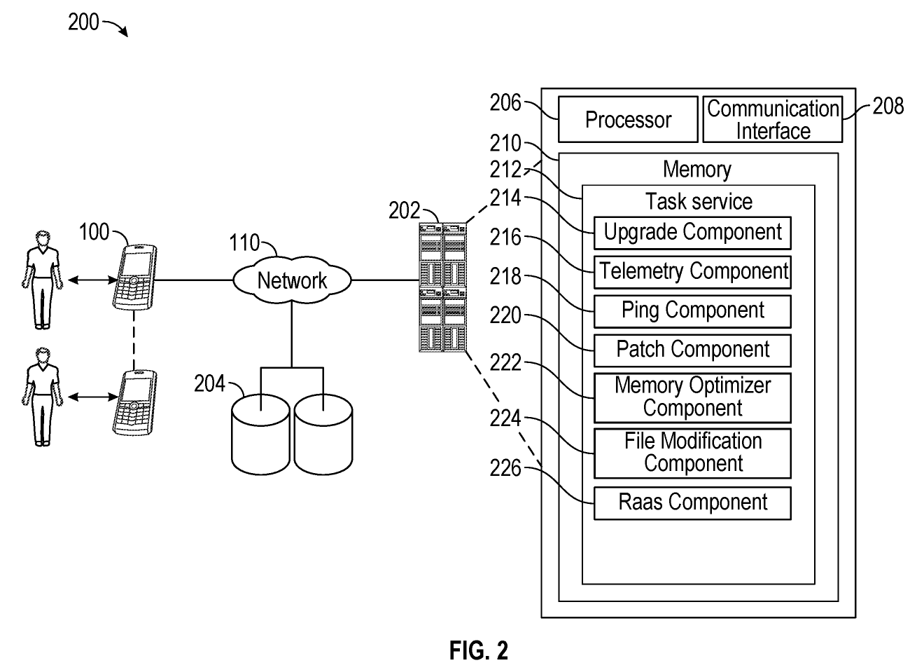

The network 110 may include any computer network, for example the Internet, a private network, local area network (LAN), wide area network (WAN), or the like. The network 110 may include various network interfaces, adapters, modems, and other networking devices for communicatively connecting the client devices 100 with application server 202 (shown in FIG. 2 and discussed in more detail below). The network 110 may also include configurations for point-to-point connections, either to application server 202 or the other client devices 100.

In some examples, the user interface component 120 includes a graphics card for displaying data to the user and receiving data from the user. The user interface component 120 may also include instructions for device drivers to operate the graphics card and display information through the previously discussed display components.

Turning again to memory 108, the operating system 119 controls the applications 116 running on the client device 110. The applications 116 may include pre-installed applications as well as applications that are downloaded from an online portal, such as an “app store.” In some examples, the operating system 119 allows applications 116 to execute tasks when the applications are in an inactive state using the background task component 124, which is discussed in more detail below.

Additionally, processor 104 captures telemetry data 122 that is stored in memory 108. As previously discussed, the telemetry data includes tracked information about from device sensors, information regarding network connectivity, user interaction information, information from the applications, or other information captured by the mobile device. Any or all of the stored telemetry data 122 may be communicated by the background task component 124 through the network 110 to the application server 202 described below in reference to FIG. 2. Examples of the telemetry data include, for example but without limitation, modifications of a document or file, gaming controls, user settings and preferences, preferred languages, messages shared, location information, user profile information, device movements and interpretations thereof (e.g., moving greater than 10-15 mph indicating car movement, less than 4 mph indicating walking, and the like), audio, images, video, device orientation (e.g., as measured by a gyroscopic sensor), peripheral interactions (e.g., BLUETOOTH® brand communications to wireless devices), or the like. Virtually any interaction with the client device 100 or data sensed by sensors of the client device 100 may be saved and stored in memory 108 as telemetry data 122.

In some particular examples, telemetry data 122 includes a “present indication” designating that an application 116 is still stored on the client device 100, and such indication is periodically (e.g., every 12 hours, daily, weekly, etc.) communicated to the application server 202 shown in FIG. 2. The present indication allows the application 202 to identify the applications 116 stored on the client device. Additional user telemetry data 122 indicating usage of the application 116 may also be communicated, and the two pieces of information are usable to identify which applications 116 are kept on the client device 100 by the user 102 and which applications 116 the user 102 is actually using.

Further still, the different user actions in the telemetry data 122 may be used by the application server 202 to determine the actions users 102 are performing on the applications 116, which, in turn, provides a trove of data that may be analyzed to determine: (a) the applications 116 that are most and least commonly used, and (b) actions the users 102 most and least commonly want to perform. Knowing the popularity of applications 116 and actions conducted therein enables the application server 202 perform a number of outreach actions to reengage users 102 with applications 116 not being used. For example, an e-mail may be sent to a user 102 to notify them of an update to the application 116, new or unused functionality in the application 116, a password to unlock additional functionality of the application 116, or some other outreach activity. Prompting users 102 in various ways has proven to be an effective way to reengage users 102 with an application 116. Additional techniques for reengaging users 102 based on the communicated telemetry data 122 are disclosed below in reference to FIG. 2.

Background task component 124 includes instructions for allowing the applications 116 to perform tasks in background threads while the applications 116 are inactive. Background task component 124 includes a background service 126, a background task executor 128, task alarms 130, task conditions 132, and a host of background tasks 134. More specifically, the background tasks 134 include an upgrade task 136, a telemetry data task 138, a ping task 140, a patch task 142, a memory optimizer task 144, a file modification task 146, and a resource as a service (“RaaS”) task 148. Additional or alternative background task components 124 and background tasks 134 may be used in other examples.

The background service 126 provides a Background Task Host service on the client device 100 that is responsible for executing the background tasks 134 when applications 116 are inactive. In some examples, to enable the background threads for the applications 116 to function when inactive, the background service 126 is instantiated or otherwise called, and the implementation of background tasks 134 are derived from an interface referred to herein as “IBackgroundTask.” In some examples, the IBackgroundTask interface constitutes the following functions:

TABLE 1
IBackgroundTask Interface Calls

| Type | Function | Comment |
|---|---|---|
| String | getTag( ) | Returns a unique string identifier (or |
| | | name) of the background task. |
| Int | getTriggerFlags( ) | Returns the flags describing the |
| | | triggers at which this Task |
| | | should be executed. |
| | | Use a combination of flags to register |
| | | with multiple events. For example, |
| | | (TRIGGER_PACKAGE_UPGRADE\| |
| | | TRIGGER_OFF_PEAK_HOURS_ |
| | | DAILY) specifies that the task must |
| | | be executed when the application is |
| | | upgraded and also daily once during |
| | | the off peak hours. |
| Int | getFlags( ) | Returns the flags describing the |
| | | various conditions that need to |
| | | fulfilled before executing this task. |
| | | Use a combination of flags to |
| | | specify multiple conditions. |
| | | For example, |
| | | (FLAG_REQUIRE_BATTERY_ |
| | | STATUS_CHARGING \| FLAG_ |
| | | REQUIRE_NETWORK) specifies |
| | | that before running this task ensure |
| | | that the device battery is plugged |
| | | AND that the device has an active |
| | | network connection. |
| Void | onPreExecute | Runs on the main thread of the Service |
| | (Context context) | before the actual execution of the task. |
| | | Perform setup operations. |
| Void | Execute | Override this method to perform an |
| | (Context context) | operation on the Background thread. |
| | | This is the core of the Service Task. |
| Void | onPostExecute | Runs on the main thread of the Service |
| | (Context context) | after Execute( ) finishes executing. |
| | | Perform tear-down operations. |

In some examples, the aforesaid method calls onPreExecute( ), Execute( ), and onPostExecute( ) are implemented in a synchronous manner, meaning each method should return only when it has completed executing whatever it needs to execute. If, for example, the method Execute( ) spawns a new thread in its implementation and returns before waiting for that thread to complete execution, the results are undefined. Additionally or alternatively, the following constants may be defined in the interface IBackgroundTask:

TABLE 2
IBackgroundTask Constants

| Type | Constant | Comment |
|---|---|---|
| int | TRIGGER_ | Use in the implementation of |
| | PACKAGE_ | getTriggerFlags( ) to specify that a task |
| | UPGRADE | must be executed when a new version of |
| | | your application has been installed |
| | | over an existing one. |
| int | TRIGGER_OFF_ | Use in the implementation of |
| | PEAK_HOURS_ | getTriggerFlags( ) to specify that a task |
| | DAILY | must be executed daily during the off- |
| | | peak hours (between 0100 Hours to |
| | | 0400 Hours). |
| int | FLAG_REQUIRE_ | Use in the implementation of getFlags( ) to |
| | BATTERY_ | specify that a task must be executed only if |
| | STATUS_FULL | the device battery is fully charged. |
| int | FLAG_REQUIRE_ | Use in the implementation of getFlags( ) to |
| | BATTERY_ | specify that a task must be executed only if |
| | STATUS_60PC | the device has at least 60% battery. |
| int | FLAG_REQUIRE_ | Use in the implementation of getFlags( ) to |
| | BATTERY_ | specify that a task must be executed only if |
| | STATUS_ | the device is plugged for battery charging |
| | CHARGING | (either AC or USB). |
| int | FLAG_REQUIRE_ | Use in the implementation of getFlags( ) to |
| | NETWORK | specify that a task must be executed only |
| | | when the device has an active network |
| | | connection. |

For initialization of the Background Task Host service, the background service 126 may, in some examples, first need to be registered in an application's package manifest file (e.g., the file used to download or otherwise initialized the application 116). This may come into effect only after the application 116 is launched for the first time, or if the application 116 is a pre-installed application 116.

In some examples, the background service 126 is triggered—or called by an application 116—at a particular time using the stored task alarms 130 or task conditions 132. Task alarms 130 refer to times and/or days for executing a task using the background service 126. Examples include, without limitation, running a task at a particular time in the morning, running a task at the beginning of the month, or the like. Task alarms 130 may be scheduled to not be fired at a fixed hour during the night every day to reduce the network impact of a large collection of customers in the same time zone trying tasks at the same moment. To avoid this situation, each client device 100 may schedule task alarms 130 at a random time between certain evening or morning hours (e.g., between 1:00-4:00 am). This ensures that the load on the application server 202 discussed below is evenly distributed during this time duration.

Task conditions 132 refer to conditional events that trigger a background task to run. Examples include, without limitation, running a task after an application 116 has been upgraded, after a user 102 has recently (e.g., within 12 hours) run an application 116, updating a font list on a server, making a patch available on a server, threshold battery levels dropping below or raising above certain battery thresholds or percentages (e.g., above 30%), after “airplane mode” is activated on the client device 100, after a wireless connection is available on the client device 100, after all wireless connections have been disconnected from the client device 100, after the user has switched the language or time zone of the client device, or the like.

In some examples, the background service 126 first identifies the task trigger (i.e., task alarms 130 and conditions 132) that caused the background service 126 to wake up. The background service 126 may then iterate over the background tasks 134 to determine which of the tasks are associated with the current trigger. The background tasks 134 may then be executed by the background task executor 128 at the triggered alarm times conditions.

To differentiate between various task alarm 130 and condition 132 triggers, some examples use the action parameter called “Intent.” To invoke the background service 126, a new Intent is created and fired to upgrade a downloaded application 116 as follows:
Intent intent=new Intent( );
intent.setAction(ACTION_PACKAGE_UPGRADED);
context.startService(intent);
   When the background service 126 is triggered, in some examples, the action parameter will be queried to determine the purpose or trigger. The action parameter is converted to the trigger constant defined by the operating system 119 or the application 116. Then, trigger flags of the various background tasks 134 may be identified by the background service 126 and used to identify when to run the various background tasks 134. For example, as discussed in more detail below, the ping task 140 may be set to launch once every day at a particular or alternating times by having a task alarm 130 specifying trigger times accordingly.

In some particular examples, the following action values are, in some examples, handled by the background service 126:

TABLE 3
Action Values Handled by IBackgroundTask

| Type | Action Value | Comment |
|---|---|---|
| String | ACTION_PACKAGE_ | A new version of the application has |
| | UPGRADED | been installed over an existing one. |
| String | ACTION_OFF_PEAK_ | A task alarm has fired during Off-Peak |
| | HOURS_DAILY | hours for the user. |
| String | ACTION_PACKAGE_ | A new version of the application has |
| | UPGRADED | been installed over an existing one. |
| String | ACTION_OFF_PEAK_ | An alarm has fired during Off-Peak |
| | HOURS_DAILY | hours for the user. |
| String | ACTION_PACKAGE_ | A new version of an application has |
| | UPGRADED | been installed over an existing one. |
| String | ACTION_OFF_PEAK_ | An alarm has fired during Off-Peak |
| | HOURS_DAILY | hours for the user. |

The aforesaid values in Table 3 mention “Off-Peak hours,” which may include any block of time that the client device 100 is typically not being used by the user 102. These Off-Peak hours may be determined from actual patterns of usage of the client device 100, pre-determined Off-Peak times, usage of client devices 100 of other users 102, historical network connectivity of the client device 100, historical network connectivity of the client devices 100 of other users 102, or a combination thereof, all of which may be determined from the telemetry data 122.

For example, the Off-Peak timeframe may be set by the user 102 or the client device 100 manufacturer to be 2:00-4:30 am. Alternatively, the Off-Peak timeframe may be set based on the telemetry data 122 indicating the user 102, or other users 102, have historically be active users of the client device 102 between 2:00-4:30 am. Other examples set the Off-Peak hours to coincide with the connectivity patterns of last X number of pre-determined days, specifying times in which the client device 100 has historically experienced faster network connections, or waiting until the client device 100 is connected to historically faster network connections (e.g., faster fiber connections or hard-lined connections compared to slower Wireless Fidelity (Wi-Fi) connections).

Once triggered, execution of the various background tasks 134 is handled by the background task executor 128. In some examples, the background service 126 manages execution of the triggered tasks by the background task executor 128 sequentially one after another or in parallel if the operating system 119 permits. Also, some examples may execute the background tasks 134 along with the application 116 itself—e.g., when the application is launched into an active state during a task alarm 130 or task condition 132. In such cases, synchronization between the two executions may be performed, because it could be disastrous to have the same task 134 executed by two different threads at the same time. To fulfill this requirement, there are two aspects to consider: (1) ensuring the task 134 does not get executed simultaneously on two different threads, and (2) ensuring that the application 116 itself is not running when the task 134 is executed by the background service 126.

In some examples, mitigation of the above two aspects may be accomplished using three operations. First, the background service 126 is run in separate execution process with a separate memory space than the application 116 itself. Because the background service 126 has a separate memory space, it will not conflict with the application 116. Second, the application 116 starts up, the application 116 will end the background service 126. Ending the background service 126 is easily performed because the background service 126 is running in its own execution process. To do so, some examples retrieve the process identifier (“process ID”) of the execution process hosting the background service 126 and make an operating system call to end that particular execution process. Third, when the background service 126 starts up, the background service 126 is configured to check if the application 116 is running and then end itself (i.e., the background service 126) if so. To check if the application 116 is running, an in-memory object cannot be used because the memory space is different for the background service 126 than the application 116. So some examples make use of the disk of memory 108 to determine whether the two are running. In one implementation, a new class called “AppActivityTracker” was created that makes use of the FileLock capability in JAVA® to take a read-write lock on a file on the disk. When an activity of the application 116 is launched, the AppActivityTracker may take a lock and release the lock when the Activity is complete, or otherwise destroyed. If the background service 126 tries to access this file while the application is running, it will not be granted such access.

In operation, the background service 126 executes one or more of the background tasks 134 for a given application 116 when the application 116 is not running, i.e., inactive. So the background tasks 134 are so critical that the application 116 cannot run or function properly if the background task 134 is not executed. In this same vein, the background tasks, in some examples, do not involve any user interface (“UI”) manipulation. If UI manipulation is detected by the background service 126 in the background tasks 134, the so-detected background task 134 may be terminated, in some examples.

Performing the background tasks 134 on background threads enhances the user experience by eliminating non-user oriented tasks to be performed during times of device inactivity. It also drastically enhances the readiness of the applications themselves by keeping them up-to-date on a daily, or perhaps hourly basis. Applications that function more efficiently for the user are used more frequently and do not run the risk of crashing the client device 100 by trying to perform too many tasks every time at launch. For instance, if launching an application 116 always initiates a download of bug patches for the application 116, processing power must be used to retrieve and apply these bug patches. If the device is also performing other operations (e.g., trying to maintain a tenuous network connection), this extra processing strain may cause the device to crash. Thus, the disclosed examples herein enhance performance of the client device 100 by organizing the background tasks 134 to be performed at more opportune times when the client device 100 is not being used as heavily.

Having described the framework for performing the background tasks 134 on background threads while the applications 116 are inactive, some example background tasks are discussed in more detail. As shown in FIG. 1, the background tasks may include the upgrade task 136, the telemetry data task 138, the ping task 140, the patch task 142, the memory optimizer task 144, the file modification task 146, and the RaaS task 148. In addition to being schedule to operate when the applications 116 are inactive and on background threads, the background tasks 134 may be scheduled to execute completely transparent from the user, e.g., without user prompting. Other background tasks 134 may be performed as well, as this list is not meant to be exhaustive.

The upgrade task 136 upgrades the version of the application 116, when a new version is available. For example, if the application 116 needs to be updated, the applications 116 may take certain actions, e.g., copying the binaries from the application package to a shared library folder. In some examples, these steps are taken immediately after the applications 116 are updated. In some examples, these update tasks are only run if the application 116 is in an inactive state.

The telemetry data task 138 collects certain telemetry data 122 specified by the application 116 and transmits the collected telemetry data 122 to the application server 202 described below relative to FIG. 2. Waiting to the transmit the telemetry data 122 until the application 116 is active has shown to result in approximately 15% loss of the telemetry data 122 being received by the application server 202, largely due to loss of device connectivity before the telemetry data 122 is sent. The examples disclosed herein upload select telemetry data during Off-Peak timeframes or during certain network connectivity times (e.g., during faster Internet connection speeds, connection to particularly reliable Internet connections, or the like). Optimally transmitting the telemetry data 122 when the client device 100 is not as heavily used or network 110 connections are more reliable has shown to drastically reduce the amount of telemetry data that is lost.

The ping task 140 provides a periodic (e.g., 12-hour, daily, weekly, monthly, etc.) message, referred to herein as the “ping message,” to the application server 202 that an application 116 is still installed on the client device 100. Usage metrics may actively be tracked using the telemetry data 122, but conventionally there is no reliable way to track how many customers are uninstalling the application 116. To this end, the ping task 140 provides the periodic ping message that the application 116 is still installed on the client device 100.

The notification may be correlated to the telemetry data 122 sent from the telemetry data task 138 to determine how much the users are actually engaging with the application 116. Users who have not used the application 116 more than a threshold number of times (e.g., 3 times) within a given time period (e.g., 3 months) may be provided a notification message (e.g., text or e-mail message) that gently reminds them of the application, e.g., a notification messages specifying new or unused features of the application 116. This notification message may be standard for all users 102 or specific to a user 102 based on the telemetry data 122. To illustrate the latter, the telemetry data may indicate that a user has repeatedly launched an application 116 but will not create an account at the opening UI screen, which requires entry of the user 102's e-mail address. A notification message may be sent to the user 102 directing them to a way to sign up with the application through a social media account indicated in the telemetry data 122, instead of having to provide an e-mail address. Numerous other scenarios exist in which the ping task 136 notification may be analyzed with the telemetry data 122 to trigger notification messages for the user 102.

The patch task 142 stores indications of bugs and the failures of the applications 116 as telemetry data 122 and transmits the bug and failure information to the application server 202. In some examples, the patch task 142 downloads updated native libraries that include the fix for the bug from the application server 202 server and patch the installed application 116 with updated native libraries to fix the bug on the fly and with very low turnaround time. Conventionally, bugs of an application 116 need to be patched through downloading of an update. The patch task 142 enables individual bugs to be patched in the background of the client device 100, thereby fixing bugs much faster and with far smaller downloaded files—because entire versions of the applications 116 do not need to be downloaded.

The memory optimizer task 144 reduces the amount of memory of a downloaded application 116 that is stored in cache 112 when the application 116 is not being frequently used. In some examples, the application 116 is downloaded and initially placed all in cache 112 for quick access. If the user 102 routinely uses the application 116 (e.g., once a day, once a week, bi-monthly, or the like), the entirety, or at least a large portion of the downloaded file for the application 116 is kept in cache. When the user 102 stops or does not use the application 102 so frequently (e.g., more than 30 days between usage), a portion of the application 116 may be moved out of cache 112 into less quickly accessible storage of memory 108, e.g., on disk space to make room in cache 112 for more frequently used applications 116. In some examples, this determination of whether to move portions of the application 116 in and out of the cache 112 is made by the application server 202 based on the shared telemetry data 122 indicating how frequently the application 116 is being used.

If a client device 100 goes into a low disk space state, users 102 are more likely to uninstall applications that are less frequently being used. To mitigate disk issues for infrequent users 102, some examples run the memory optimizer task 144 every night and to check for application usage. If un-favorable, meaning the application 116 is used less than a threshold number of times in a given time period, application libraries are removed from the cache 112.

For example, an application that is 500 MB may initially be placed entirely in the cache 112 so long as the user 102 is running the application 116 every month. But if the user 102 stops running the application 116 every month, telemetry data 122 indicating so triggers the application server 202 to signal the patch task 142 to move 250 MB of the application 116's executable or support files out of the cache and to the disk of the memory 108.

In another example, the full 500 MB file may be stored on the less frequently readable disk while the portion of the 500 MB (e.g., 150 MB) stored in the cache 112 is deleted or reduced as the application 116 is used less frequently. If the application 116 is once again used more frequently, more of the application 116's file may be stored on the disk may be moved to the cache 112. In other words, such embodiments always store the entire file of the application 116 in slower memory, providing the ability to download more of the application 116 to the cache 112 whenever the user 102 frequently uses the application 116. Again, the application server 202 may control this movement of data for the application 116 into and out of the cache 112 based on the telemetry data 122 indicating the amount of application 116 usage.

The file modification task 146 uploads changes to files made on the client device 100 to a cloud-based task service 212 shown in FIG. 2 when the application 116 is inactive in order to marry with changes with a server-stored version of the document. Likewise, changes made to the server-stored version of the document may be updated on the client device 100 while the application 116 for accessing the document is inactive. For example, if a user 102 is working on a text document, changes to the text document made by another user 102 that have been uploaded to the application server 202 may be communicated to the client device 100 and used to update the locally stored version of the text document by the file modification task 146. Virtually any file may be updated in this manner, e.g., video files, images, presentations, spreadsheets, audio files, or the like. And updating files using background processing improves the performance of the client device 100 by keeping the latest copy of the document available for user. This considerably improves the user experience, because he/she can rely the latest copy of document to be always available.

The RaaS task 148 provides telemetry data 122 about preferences, locations, and/or locations of the user 102 to the application server 202, which in turn provides the package file for the application 116 with only the libraries, languages, fonts, and other associated files of the application 116 that are specific to the preferences, locations, and/or locations of the user 102. Conventionally, the same data file package for an application 116 is downloaded to all users 102. But a user 102 in one particular area of the United States may prefer a particular dialect of English or Spanish than users 102 in other areas, and the user 102 may have no need for all the libraries in other languages (e.g., Chinese, Japanese, German, etc.). As such, users 102 unnecessarily pay the download cost of higher package sizes for languages they are never going to use. To counter this, some examples only provide the language and UI resources that are specific to the user 102's preferences, locations, and/or locations, and the rest of the full download package file (e.g., all languages and functions) are stored on the application server 202. If any of these additional resources are needed (e.g., if a user moves to a new location), the application 116, through the RaaS task 148, may download the needed resources.

Additional resources may be identified through telemetry data 122 indicating the preferred language a user drafts e-mails, takes notes, speaks, receives voice mails, watches videos, accesses the World Wide Web, prepares text messages, or otherwise receives correspondence, and downloaded in the background. Providing resources in this on-demand manner has shown to reduce downloaded files and disk usage by up to 15 MB in some modern applications 116. It allows supports more languages without penalizing existing users 102 because only the languages that are needed are downloaded.

The loading of native libraries is a requirement which many background tasks 134 may require. To this end, the background service 126 manages the loading of libraries by the background tasks 134 to avoid duplicative loading and initialization of native libraries. In some examples, a “library loader” task (not shown) loads the libraries required at each trigger of the background service 126, loading only the minimum libraries needed to complete the various background tasks 134 that identified to be performed. Other libraries may be added as needed.

FIG. 2 is an exemplary block diagram illustrating a networking environment 200 for providing background services to a client device 100. Networking environment 200 involves numerous client devices 100 described above in reference to FIG. 1 communicating over the network 110 with an application server 202. A database cluster 204 is also communicatively coupled to the network 110 and accessible by the application server 202 and/or the client devices 100. The depicted devices are provided merely for explanatory purposes and are not meant to limit all examples to any particular device configuration. Also, the application server 202 and database cluster 204, while shown in singular boxes, may involve multiple physical or virtual (e.g., in a virtual machine architecture) servers or database structure.

The application server 202 is a server or collection of servers configured to receive the transmitted telemetry data 122 from the client devices 100 and respond to the various background tasks 134 being executed thereon. Specifically, in some examples, the application server 202 includes its own processor(s) 206, communication interface(s) 208, and computer-storage memory 210 that enable it to communicate with the client devices 100 and the database cluster 204 and execute the various task services 212 that are stored in the memory 210. In particular, the task services 212 in memory 210 include, for example but without limitation, an upgrade component 214, a telemetry component 216, a ping component 218, a patch component 220, a memory optimizer component 222, a file modification component 224, and an RaaS component 228. These various task components 214-228 mirror and respond to the background tasks 134 shown in FIG. 1 and described above.

The database cluster 204 represents one or more backend storage devices (e.g., servers) configured to store any of the telemetry data 122 described herein for the users 102 of the client devices 100. As a repository of the telemetry data 122, the database cluster 204 may be mined to determine specifics of the applications 116 that appeal to the user 102. Actions of the users 102, usage statistics, languages, network connections, notifications that prompted users 102 to reengage with the applications 116, or any other telemetric data about the users 102 and the applications 116 may be stored and mined to learn what appeals and does not appeal to users 102.

The database cluster 204 may also include specialized components processing incoming market, product, social, news, and industry data along with the telemetry data 122 to correlate application 122 popularity to news and current events. For example, major predefined sporting events may trigger higher usage of sporting-news applications 116. This correlation may be used by the various task services 202 to schedule different background tasks 134 to execute on the client devices 100, e.g., bug fixes may be scheduled not to occur during the Super Bowl.

In operation, the various task services 212 respond and/or control the background tasks 134 being performed on inactive applications 116 of the client devices 100. Looking at the task services themselves, the upgrade component 214 provides the latest versions, upgrades, libraries, software components, or the like (collectively “upgrade files”) of an application 116. In some examples, upgrade files are requested by the upgrade task 136 upon triggering task alarms 130 or task conditions 132, and the upgrade component 214 identifies the latest upgrade files (e.g., since prior downloads by the client device 100) and transmits them back to the client device 100. Alternatively, upgrade files may be scheduled to be pushed to the client devices 102 at predetermined times specified by an administrator or the client devices 102 themselves, and if the application 116 is running, or active, when the upgrade files are downloaded, the upgrade task may discard or store the upgrade files for later installation when the application is inactive.

The telemetry component 216 receives the various telemetry data 122 from the client devices 100 and stores it locally or in the database cluster 204. The telemetry data 122 may then be exposed to the other task services 212 for use in determining files or notifications to provide the client devices 100.

The ping component 218 receives and stores the periodic ping message indicating that an application 116 is still installed on a client device 100. This message may be stored—either on the application server 202 or in the database cluster 204—and used by the application server 202 to determine various other actions for the application 116. The ping message and the telemetry data 122 together indicate how long an application 116 is still downloaded on a client device and the user 102's usage of the downloaded application 116. If the application 116 is rarely being used (e.g., less than a threshold number of times during a specific time period), the ping component 216 may trigger the memory optimizer component 222 to notify the client device 100 to reduce specific files—or a quantity of files—stored in cache 112. In another example, notification messages attempting to reengage the user 102 with the application 116 may be generated by the ping component 218 and sent to the user 102, either directly to the client device 100 or via a messaging application (e.g., e-mail, short message service (SMS), or the like).

The patch component 220 receives indications of bugs or failures of the applications 116 and responds with patches or other files for fixing the bugs and preventing the failures. In some examples, the patch component 220 provides the patch task 142 on the client device 100 with updated native libraries that include fixes identified bugs that may be used to fix the bug on the fly.

The memory optimizer component 222 analyzes the telemetry data 122 and determines whether to move portions of an application 116 into or out of the cache 112 on the client device 100 based on the how frequently the application 116 is being used. For example, applications 116 that are used daily or weekly may have more of their executable files added to the cache 112 than applications 116 used bi-monthly or monthly. Examples may set the determined timeframes to virtually any threshold, e.g., hours, days, weeks, months, etc. In operation, the memory optimizer component 222 signals the client device 100 when to move files of the application 116 into and out of cache 112, and in some examples, what files to the move.

To mitigate disk issues for infrequent users 102, some examples run the memory optimizer task 144 on the client devices 100 every night and to check for application usage, and this application usage information is communicated to the application server 202 and used by the memory optimizer component 222 to determine the need to move application 116 files in and out of cache 112. In some examples, only the top threshold quantity (e.g., 5-20) of most frequently used applications 116 are signaled to have files stored in cache 112, and the memory optimizer task 144 mines the telemetry data 122 to determine which applications are most frequently used. In other examples, the developer of an application 116 may also manage and provide the memory optimizer component 222, and directs only the applications 116 of the developer to move files into and out of cache 112. These are only some of the examples that are possible in the background framework disclosed herein. Other examples may move application 116 files into and out of cache 112 based on different combinations of telemetry data 122—e.g., seasonal events or usage, network connectivity, current events, historical device 100 usage, or the like.

The file modification component 224 monitors files that are stored in a cloud service provided by either the application server 202 or the database cluster 204. When files are changed (e.g., edits made to a shared document or spreadsheet), the changes are communicated to the client device 100 identified to be locally storing a version of the shared document upon receipt of a request from a file modification task 146 transmits an indication that the application 116 on the client device 100 is inactive. Put another way, the file modification task 146 may be triggered to request changes to any document supported by an application 116 and locally stored on the client device 100 (e.g., using file names or other unique identifiers), and the file modification component 224 responds with the changed shard files or modifications to the previous version of the shared files so that file modification task 146 may store the updated file locally while the application 116 is inactive.

The RaaS component 226 analyzes the telemetry data 122 for preferences, languages, and locations of the user 102 and responds to the RaaS task 148 with user-specific package file for the application 116 that only have some—not all—of the libraries, languages, fonts, and other associated files of the application 116 specific to the preferences, languages, and locations of the user 102. In some examples, the RaaS component 226 only selects the language and UI resources that are specific to the user 102's location and preferences indicated in the telemetry data 122 and provides those language and UI resource files back to the RaaS task 148.

Location may be determined through GPS sensor data, accelerometer and cellular triangulation data, or the like. One skilled in the art will appreciate and understand that numerous techniques exist for determining user 102 locations.

Language is determined, in some examples, by the language in which the user 102 communicates in messaging applications—as stored in the telemetry data 122. For example, if the user sends SMS messages in a particular dialect of English, that language is selected as the user's preferred language. Language may be detected through messaging applications (e.g., SMS, e-mail, etc.), voice recognition, background ambient noises and speech recognition (e.g., people talking in the background of a video-chat experience), language used in an active keyboard, or the like. In one particular example, the language used in an SMS messaging application is used to determine the language of the user 102.

Preferences of the user may be gleaned from various types of telemetry data 122. Social media, friends, contacts, payment options, browser history, messaging history, messaging languages (e.g., language used in text or e-mail messaging), slang, dialects, application usage, device 100 usage, network usage, device 100 sensor data, demographics (e.g., age, ethnicity, gender, etc.), or the like. User preferences may be gathered by analyzing the telemetry data 122 to understand various patterns of the user 102, or to compare such telemetry data 122 to the determined patterns of other users 102 to develop a crowd-sourced determination of user preferences. For instance, the users 102 of the same—or near same (e.g., within two years)—age, same gender, and same location may be assigned the same preferences by the RaaS component 226, e.g., preferences of particular languages, dialects, messaging applications, usage patterns, browsing patterns, or the like.

The RaaS component 226 provides the select files of the application 116 for the individual users 102 based on the determined preferences and location. If additional files are needed (e.g., other language libraries), the RaaS task 148 may request the additional files from the RaaS component 226, which responds with the specifically requested files.

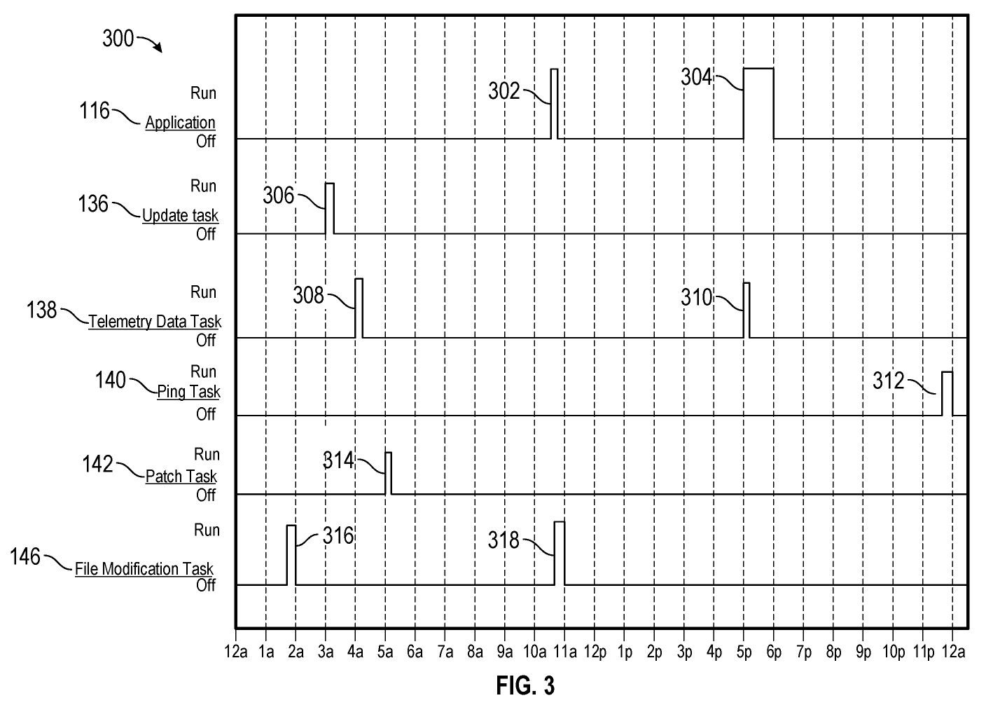

FIG. 3 is a multi-axis timeline 300 diagram illustrating various background tasks 136, 138, 140, 142, and 146 being executing at times when the application 116 is inactive. The y-axis of timeline 300 shows when the application 116 and tasks 136, 138, 140, 142, and 146 being in active (shown by “Run”) and inactive (shown by “Off”) states. The x-axis reveals a twenty-four-hour period of a single day. As shown, the application is only active twice: for fifteen minutes around 10:30 am, and for an hour between 5:00-6:00 pm. As shown at 306, 308, 312, 314, and 316, various tasks 136, 138, 140, 142, and 146 are run in when the application 116 is inactive, specifically at times when the user 102 is most likely asleep and/or network connectivity is readily available—during the hours of 1:00-5:15 am and 11:30 pm. Thus, tasks may be seamlessly performed in the background when the application 116 is inactive and the user 102 is most likely not going to be bothered by the extra processing of the tasks.

Additionally, two of the tasks, the telemetry data task 138 and the file modification task 146, are triggered to also run when the application 116 is active—e.g., upon application 116 launch or closure. As shown at 318, the file modification task 146 updates files that have been changed while the application 116 is run—for instance, immediately upon editing of the files. And as shown at 310, the telemetry data task may be scheduled to run during one of the times the application 116 is run daily, transmitting recent telemetry data 122 of the user 102 or the client device 100. FIG. 3 is but one example illustration of some background tasks 134 running in relation to the times the application 116 is active and inactive.

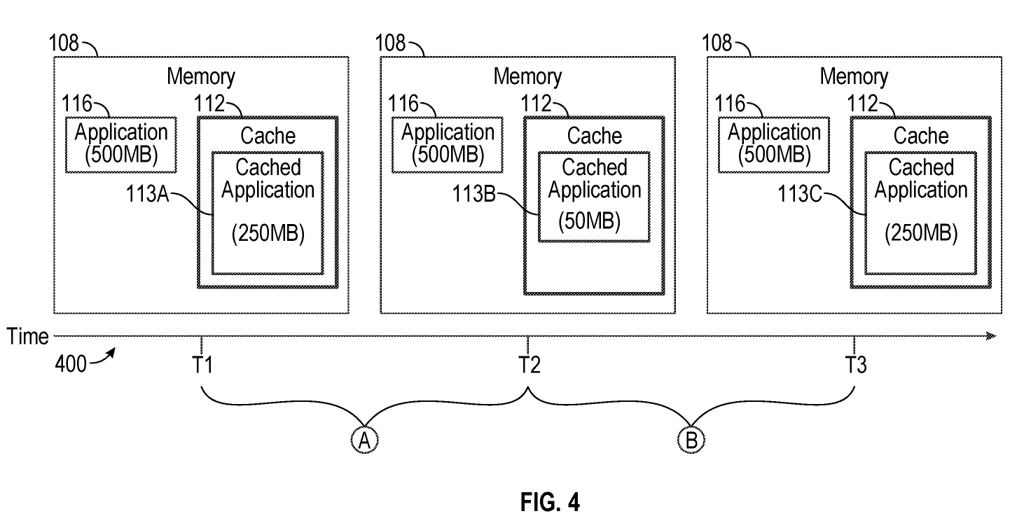

FIG. 4 is a single-axis timeline 400 diagram illustrating files being moved into and out of cache 112 of memory 108. The x-axis shows three different times: T1, T2, and T3. The application 116 itself contains a package file that is 500 MB in size, and that is always stored in slower, less-accessible storage of memory 108. Cache 112 is initially used to store 250 MB of the application 116 at T1 (shown as cached application 113A) when the application 116 is recently downloaded, initialized, or run. At T2, when enough time A has passed in which the application 116 has not been used (e.g., more than a month), the amount of the package file of the application 116 stored in cache 112 (cached application 113B) is reduced to 50 MB. At the same time, the entire package file is stored in the slower storage of memory 108 in case the application is re-used and non-cached file contents are needed. At T3, after time B, the application 116 is used again, and cached application 113C stored in cache 112 swells to 250 MB again, either upon relaunching of the application and instruction of the memory optimizer task 144 or upon instruction of the memory optimizer component 222 from the application server 202. Thus, the cache 112 may be used to the strategically and selectively store files of application 116 based on application usage.

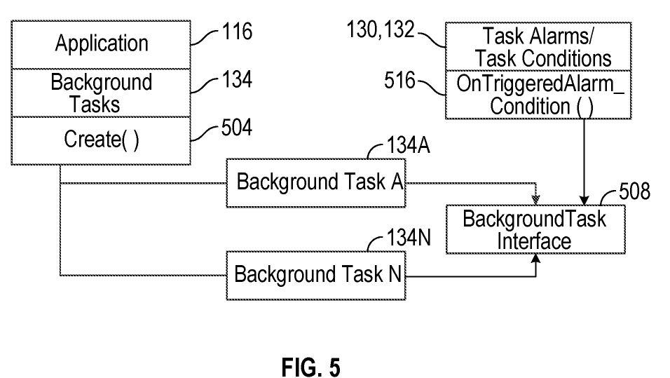

FIG. 5 is a block diagram of a framework for implementing application tasks in background threads of the client device 100. Application 116 is associated with various background tasks 134 that have been flagged by different task alarms and conditions 130, 132 to be executed on background threads of the client device 100. A function called “Create( )” 504 is used to create the various background tasks 134A-N, and these background tasks are called to execute upon triggering by the task alarms and conditions 130, 132 being executed by function “OnTriggeredAlarm_Condition( )” 516. When the conditions are met, value is send to the Background Task Interface (e.g., IBackgroundTask disclosed above) 508 that then performs the triggered background tasks 134A-N while the application 116 is in active. The shown framework enables the background tasks 134A-N to fire on triggers that are independent of the application 116 itself, thereby enabling these tasks to be performed on background threads.

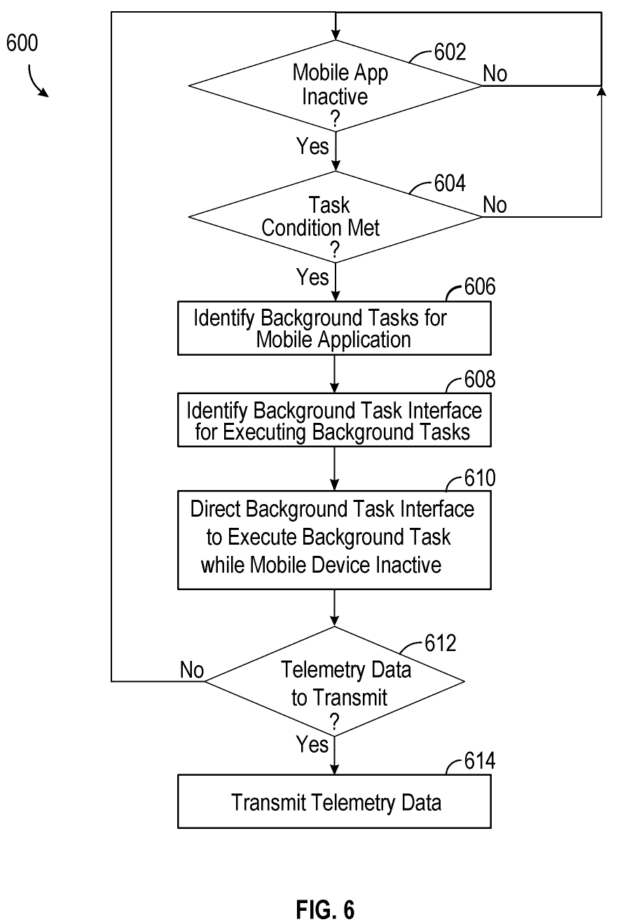

FIG. 6 is a flowchart diagram showing an executable work flow 600 for processing background tasks 134 of mobile applications 116 while the mobile applications 116 are inactive. Initially, the mobile applications 116 on a mobile client device 100 are monitored to determine whether they are in active or inactive states, as shown at decision box 602. For applications 116 that are inactive, the background service 126 monitors the associated task alarms 130 and task conditions 132 to determine whether any background tasks are to be executed, as shown at decision box 604. Work flow 600 repeatedly monitors the inactivity of the applications 116 and the corresponding task alarms 130 and task conditions 132 until an inactive application 116 has a background tasks 116 that is triggered. As mentioned above task alarms 130 may be set for Off-Peak timeframes determined by the background service 126 to be time the user 102 has historically not used a particular mobile application 116 or the mobile device 100 itself (e.g., during early morning hours), and task conditions 132 may be based on the telemetry data 122 indicating various events (e.g., exceptional network connectivity, movement into a particular geographic area, social events, or the like). In some examples, task alarms 130 or task conditions 132 triggered while the application 116 is active may be disregarded and later rescheduled to be processed when the application 116 is once again inactive. In other examples, the task alarms 130 or task conditions 132 triggered while the application 116 is active may be processed on regular, non-background computation threads.

When the task alarms 130 or task conditions 132 are triggered while application 116 is inactive, corresponding background tasks 134 (e.g., upgrade task 136, telemetry data task 138, ping task 140, patch task 142, memory optimizer task 144, file modification task 146, RaaS task 148, or the like) that are scheduled with the triggered task alarm 130 or task condition 132 are identified, as shown at 606. To execute the identified background tasks 134, a background task interface 508 is also identified, as shown at 608, and directed to the execute the various background tasks 134 while the mobile client device 100 is inactive. As shown at decision block 612, if any telemetry data 122 is associated with the executed background task 134, that telemetry data 122 is retrieved and (as shown at 614) transmitted to an application server 202 for storage and usage by the task services 212 mentioned herein.

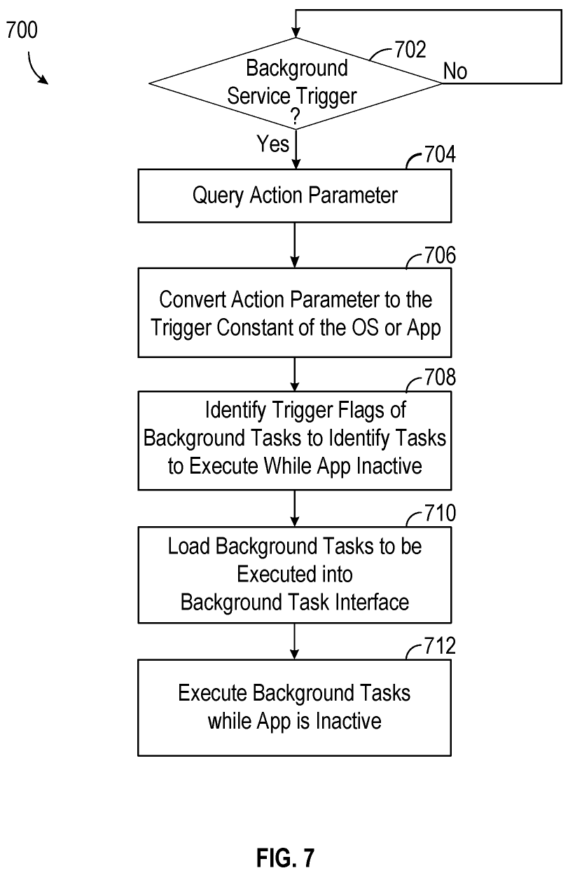

FIG. 7 is a flowchart diagram showing an executable work flow 700 for processing background tasks 134 of mobile applications 116 while the mobile applications 116 are inactive. Initially, background service 126 triggers are monitored until a background task 134 is scheduled to be processed on a background thread, as shown at decision block 702. Such monitoring may include checking the task alarms 130 and task conditions 132. As shown by the Yes path from decision box 702, when the background service 126 is triggered, in some examples, the action parameter will be queried to determine the purpose or trigger, as shown at 704. In some examples, the action parameter is converted to the trigger constant defined by the operating system 119 or the application 116, as shown at 706. Then, trigger flags of the various background tasks 134 may be identified by the background service 126 and used to identify tasks to execute while the application 116 is inactive, as shown at 708. For example, as discussed in more detail below, the telemetry data task 138 may be set to launch once every day at a particular or alternating times.

In some examples, the background service 126 manages execution of the triggered background tasks 134 by the background task executor 128 sequentially, one after another or in parallel, if the operating system 119 permits. To this end, the background tasks 134 are loaded into the background task interface 508, as shown at 710. Once loaded, the background tasks 134 are executed while the application is inactive, as shown at 712.

### ADDITIONAL EXAMPLES

Some examples are directed to a device for creating an AI negotiation agent. The AI negotiation agent includes memory storing instructions for receiving buying parameters from a user for a product or service and a processor. The processor is programmed for: (1) determining at least one negotiation elasticity threshold associated with at least one of the buying parameters; (2) directing an application server to create the AI negotiation agent, based on the buying parameters and the at least one negotiation elasticity threshold associated with the at least one of the buying parameters, to represent automatically identify at least one seller of the product and negotiate offer terms for the product or service; (3) receiving the negotiated offer terms for the product or service; and (4) presenting the negotiated offer terms for the product or service to the user.

Some examples are directed to a mobile client device configured to perform at least one background task associated while a mobile application is inactive on a mobile computing device. The mobile client device includes memory configured for storing the mobile application, the at least one background task to be executed when the mobile application is inactive, and at least one task condition for triggering the execution of the background task while the application is inactive. One or more than one processors are programmed for: detecting that the mobile application is inactive, identifying a triggering event associated with the at least one task condition for triggering the execution of the background task while the mobile application is inactive, and executing the at least one background task while the mobile application is inactive based on the triggering event being met.

Some examples are directed to performing at least one background task associated with a mobile application on a mobile client device while the mobile application is inactive. A background task interface is provided for executing the at least one background task while the mobile application is inactive. Task alarms or conditions are monitored, and when triggered, the background task interface execute the at least one background task associated with the mobile application while the mobile application is inactive.

Some examples are directed to one or more computer-storage memories with executable instructions for performing at least one background task associated with a mobile application on a mobile client device while the mobile application is inactive. At least one background task is stored along with a task condition for executing the at least one background task on the mobile client device. When the task condition is met, the at least one background task is executed while the mobile application is inactive, e.g., in a background thread of the mobile client device.

Alternatively or in addition to the other examples described herein, examples include any combination of the following:
wherein the at least one background task comprises an upgrade task executable for upgrading a version of the mobile application while the mobile application is inactive;
wherein the at least one background task comprises a telemetry data task for transmitting telemetry data across a network to an application server while the mobile application is inactive;
wherein the telemetry data comprises at least one member of a group comprising device sensors, information regarding network connectivity, user interaction information, browsing history, time stamps of application use, or digital cookies;
wherein the at least one background task comprises a ping task that notifies, while the mobile application is inactive, an application server that the mobile application is still installed on the mobile client device;
caching files associated with the mobile application, and wherein the processor is further programmed for: transmitting to an application server telemetry data stored in the memory indicating that the mobile application has been activated within a predetermined timeframe, receiving a determination from the application server based on the telemetry data indicating that the mobile application has been activated within the predetermined timeframe and notification from the ping task that the mobile application is still installed on the client device to move a portion of the files associated with the mobile application into or out of cache, and accordingly moving a portion of the files into or out of the cache while the mobile application is inactive;
wherein the at least one background task comprises a patch task configured for: transmitting bug or failure information respectively indicating a bug or failure of the mobile application and receiving task that notifies an application server that the mobile application is still installed on the client device, and receiving a patch corresponding to the bug or failure from an application server, and applying, while the mobile application is inactive, the received patch to the mobile application;
caching files associated with the mobile application, and, while the mobile application is inactive, moving at least one file of the mobile application out of the cache and into other storage of the memory incident to telemetry data indicating the mobile application has not been active within a particular timeframe;
wherein the at least one background task comprises a file modification task configured for: receiving notification from an application that a document, video, image, or audio file stored in the memory has been modified, and storing, while the mobile application is inactive, a modified version of the document, video, image, or audio file incident to the notification; and
wherein the at least one background task comprises a resource as a service (RaaS) task configured for: transmitting, while the mobile application is inactive, telemetry data indicative of a preference, location, or language; receiving a partial package file of the mobile application for installation; and installing the partial package file.

While the aspects of the disclosure have been described in terms of various examples with their associated operations, a person skilled in the art would appreciate that a combination of operations from any number of different examples is also within scope of the aspects of the disclosure.

### Example Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Computer storage media are tangible and mutually exclusive to communication media. Computer storage media are implemented in hardware and exclude carrier waves and propagated signals. Exemplary computer storage media include hard disks, flash drives, and other solid-state memory. Communication media embody data in a signal, such as a carrier wave or other transport mechanism, and include any information delivery media. Computer storage media and communication media are mutually exclusive.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, holographic devices, virtual reality devices, augmented reality devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Machine learning, natural language processing, data mining, statistical modeling, predictive modeling, deep learning, neural networks, and game theory components may be implemented on the server-side components discussed herein. Some or all of these will be used to handle the multiple inputs.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for interactive delivery of public content. For example, the elements illustrated in FIGS. 1, 2, and 5, such as when encoded to perform the operations illustrated in the accompanying flow charts, constitute exemplary means for implementing background task processing of applications on a mobile client device.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, media, and methods without departing from the scope of aspects of the disclosure, it is intended that all matter contained in the above description and shown in the accompanying drawings shall be interpreted as illustrative and not in a limiting sense.

What is claimed is:

1. A mobile client device configured to perform at least one background task associated with a mobile application stored on the mobile client device while the mobile application is inactive, the mobile client device comprising:
memory configured for storing the mobile application, the at least one background task to be executed when the mobile application is inactive, and at least one task condition for triggering the execution of the background task while the application is inactive; and
one or more processors programmed for:
detecting that the mobile application is inactive,
identifying a triggering event associated with the at least one condition for triggering the execution of the background task while the mobile application is inactive, and
executing the at least one background task while the mobile application is inactive based on the triggering event being met.

2. The mobile client device of claim 1, wherein the at least one task condition comprises a task alarm comprising a temporal timeframe.

3. The mobile client device of claim 1, wherein the at least one background task comprises an upgrade task executable for upgrading a version of the mobile application while the mobile application is inactive.

4. The mobile client device of claim 1, wherein the at least one background task comprises a telemetry data task for transmitting telemetry data across a network to an application server while the mobile application is inactive.

5. The mobile client device of claim 4, wherein the telemetry data comprises at least one member of a group comprising device sensors, information regarding network connectivity, user interaction information, browsing history, time stamps of application use, or digital cookies.

6. The mobile client device of claim 1, wherein the at least one background task comprises a ping task that notifies, while the mobile application is inactive, an application server that the mobile application is still installed along with usage pattern data and available disk space on the mobile client device.

7. The mobile client device of claim 6, further comprising:
cache storing files associated with the mobile application; and
wherein the processor is further programmed for:
transmitting to an application server telemetry data stored in the memory indicating that the mobile application has been activated within a predetermined timeframe,
receiving a determination from the application server based on the telemetry data indicating that the mobile application has been activated within the predetermined timeframe and notification from the ping task that the mobile application is still installed on the client device to move a portion of the files associated with the mobile application into or out of cache, and
accordingly moving a portion of the files into or out of the cache while the mobile application is inactive.

8. The mobile client device of claim 1, wherein the at least one background task comprises a patch task configured for:
transmitting bug or failure information respectively indicating a bug or failure of the mobile application and receiving task that notifies an application server that the mobile application is still installed on the client device,
receiving a patch corresponding to the bug or failure from an application server, and
applying, while the mobile application is inactive, the received patch to the mobile application.

9. The mobile client device of claim 1, further comprising:
cache storing files associated with the mobile application; and
wherein the processor is further programmed for moving, while the mobile application is inactive, at least one file of the mobile application out of the cache and into other storage of the memory incident to telemetry data indicating the mobile application has not been active within a particular timeframe.

10. The mobile client device of claim 1, wherein the at least one background task comprises a file modification task configured for:
receiving notification from an application that a document, video, image, or audio file stored in the memory has been modified, and
storing, while the mobile application is inactive, a modified version of the document, video, image, or audio file incident to the notification.

11. The mobile client device of claim 1, wherein the at least one background task comprises a resource as a service (RaaS) task configured for:
transmitting, while the mobile application is inactive, telemetry data indicative of a preference, location, or language;
receiving a partial package file of the mobile application for installation; and
installing the partial package file.

12. A method for performing at least one background task associated with a mobile application on a mobile client device while the mobile application is inactive, the method comprising:
storing the at least one background task along with a task condition for executing the at least one background task on the mobile client device;
providing a background task interface for executing the at least one background task while the mobile application is inactive;
determining the task condition is met; and
directing the background task interface to execute the at least one background task associated with the mobile application while the mobile application is inactive.

13. The method of claim 12, wherein the at least one background task is executed while the mobile application is inactive by an operating system for a smart phone, a tablet, a wearable device, or virtual reality device.

14. The method of claim 12, wherein the at least one background task comprises at least one of:
an upgrade task executable for upgrading a version of the mobile application while the mobile application is inactive;
a telemetry data task for transmitting telemetry data across a network to an application server while the mobile application is inactive; or
a ping task that notifies, while the mobile application is inactive, an application server that the mobile application is still installed on the mobile client device.

15. The method of claim 12, further comprising:
storing files associated with the mobile application in cache; and
moving, while the mobile application is inactive, at least one file of the mobile application out of the cache and into other storage on the mobile client device while the mobile application is inactive.

16. The method of claim 12, further comprising:
transmitting, while the mobile application is inactive, telemetry data indicative of a preference, location, or language;
receiving a partial package file of the mobile application for installation; and
installing the partial package file.

17. The method of claim 12, wherein the mobile client device comprises at least one of a smart phone, a mobile tablet, a wearable device, or a virtual reality device.

18. One or more computer-storage memories with executable instructions for performing at least one background task associated with a mobile application on a mobile client device while the mobile application is inactive, comprising:
storing the at least one background task along with a task condition for executing the at least one background task on the mobile client device;
determining the task condition is met; and
executing the at least one background task while the mobile application is inactive incident to the task condition being met.

19. The one or more computer-storage memories of claim 18, wherein the at least one background task comprises at least one of:
an upgrade task executable for upgrading a version of the mobile application while the mobile application is inactive;
a telemetry data task for transmitting telemetry data across a network to an application server while the mobile application is inactive; or
a ping task that notifies, while the mobile application is inactive, an application server that the mobile application is still installed on the mobile client device.

20. The one or more computer-storage memories of claim 18, further comprising:
storing files associated with the mobile application in cache; and
moving, while the mobile application is inactive, at least one file of the mobile application out of the cache and into other storage on the mobile client device while the mobile application is inactive.
